(19) United States
(12) Patent Application Publication
(10) Pub. No.: US 2006/0149969 A1
(43) Pub. Date: Jul. 6, 2006

(54) Authentication method of hard disk drive and recording medium storing the same

(75) Inventor: Jae-ik Song, Suwon-si (KR)

Correspondence Address: STAAS & HALSEY LLP, SUITE 700, 1201 NEW YORK AVENUE, N.W., WASHINGTON, DC, 20005, US

(73) Assignee: SAMSUNG ELECTRONICS CO.,LTD., Suwon-si (KR)

(21) Appl. No.: 11/268,466

(22) Filed: Nov. 8, 2005

(30) Foreign Application Priority Data
Dec. 30, 2004 (KR) 10-2004-0117000

(51) Int. Cl. H04L 9/00

(52) U.S. Cl. 713/182

(57) ABSTRACT

An authentication method of an external hard disk drive (HDD) and a recording medium storing the authentication method are provided. The method of authenticating a host system by the HDD accessed by the host system includes receiving authentication information from the host system, determining whether the authentication information received from the host system is identical to authentication information stored in the hard disk drive, and blocking access of the host system to the hard disk drive until the hard disk drive is turned off if it is determined that the authentication information received from the host system is not identical to the authentication information stored in the hard disk drive. Accordingly, since the HDD compares the authentication information (password) received from the host system with the authentication information (password) stored therein and allows the access of the host system only when the two passwords are identical to each other, only the authenticated host system can access the HDD.

### CROSS-REFERENCE TO RELATED APPLICATIONS

This application claims the benefit of Korean Patent Application No. 10-2004-0117000, filed on Dec. 30, 2004, in the Korean Intellectual Property Office, the disclosure of which is incorporated herein in its entirety by reference.

### BACKGROUND OF THE INVENTION

1. Field of the Invention

The present invention relates to a hard disk drive (HDD), and more particularly, to an authentication method of an external HDD and a recording medium storing the authentication method.

2. Description of the Related Art

Hard disk drives (HDDs) include a plurality of magnetic heads linked to rotating disks. The magnetic heads write information by magnetizing surfaces of the disks or read information by detecting magnetic fields on the surfaces of the disks.

Each of the magnetic heads is attached to a flexure beam to form a head gimbal assembly (HGA). The HGA is attached to an actuator arm having a voice coil that is coupled to a magnetic assembly. The voice coil and the magnetic assembly constitute a voice coil motor (VCM), and the VCM moves the magnetic head across the disk by pivoting the actuator arm.

Information is generally stored in concentric tracks on the disk. The VCM moves the magnetic head from a track to other track to access data stored in the surface of the disk. Each of the tracks includes a plurality of sectors, and each of the sectors includes a servo field and a data field.

With the trend of high capacity and compact HDDs, the size of HDDs are reduced to 2.5″ HDDs and then to 1.8″ HDDs instead of 3.5″ HDDs mainly used for desk top computers. Accordingly, the compact HDDs are more commonly used as external storage media. For example, MP3 players having HDDs may be used as external storage media for computers.

In the meantime, as the HDDs are used as external storage media, there is a demand for a security method of protecting data recorded in the HDDs by themselves. If there is no appropriate security method, user data stored in the HDDs may be arbitrarily copied by connecting them as external storage media, to computers or other information processing devices, thereby leading to illegal use of the data and secret data leakage.

### SUMMARY OF THE INVENTION

Additional aspects, features, and/or advantages of the invention will be set forth in part in the description which follows and, in part, will be apparent from the description, or may be learned by practice of the invention.

The present invention provides a method of authenticating a host system by a hard disk drive (HDD) accessed by the host system.

The present invention also provides a computer-readable recording medium storing a program for the authentication method.

According to an aspect of the present invention, there is provided a method of authenticating a host system by a hard disk drive accessed by the host system, the method comprising: receiving authentication information from the host system; determining whether the authentication information received from the host system is identical to authentication information stored in the hard disk drive; and blocking access of the host system to the hard disk drive until the hard disk drive is turned off if it is determined that the authentication information received from the host system is not identical to the authentication information stored in the hard disk drive.

The method may further comprise: recording an authentication failure count if it is determined that the authentication information received from the host system is not identical to the authentication information stored in the hard disk drive; and when there is an authentication request from the host system, rejecting the access request from the host system if the authentication failure count is greater than a predetermined number.

A runtime may be recorded at the same time when the authentication failure count is recorded, and the access request from the host system may be rejected if the authentication failure count over a predetermined time period before an accumulative runtime is greater than a predetermined number.

According to another aspect of the present invention, there is provided a computer-readable recording medium storing a computer program for a method of authenticating a host system by a hard disk drive accessed by the host system, wherein the method comprises: receiving authentication information from the host system; determining whether the authentication information received from the host system is identical to authentication information stored in the hard disk drive; and blocking access of the host system to the hard disk drive until the hard disk drive is turned off if it is determined that the authentication information received from the host system is not identical to the authentication information stored in the hard disk drive.

### BRIEF DESCRIPTION OF THE DRAWINGS

These and/or other aspects, features, and advantages of the invention will become apparent and more readily appreciated from the following description of exemplary embodiments, taken in conjunction with the accompanying drawings of which:

FIG. 1 is a flowchart illustrating a method of setting a password in a hard disk drive (HDD) in an authentication method according to an exemplary embodiment of the present invention;

FIG. 2 is a flowchart illustrating an authentication method of the HDD according to an exemplary embodiment of the present invention; and

FIG. 3 is a block diagram of a HDD using an authentication method according to an exemplary embodiment of the present invention.

### DETAILED DESCRIPTION OF THE PREFERRED EMBODIMENTS

Reference will now be made in detail to exemplary embodiments of the present invention, examples of which are illustrated in the accompanying drawings, wherein like reference numerals refer to the like elements throughout. Exemplary embodiments are described below to explain the present invention by referring to the figures.

According to an authentication method according to an exemplary embodiment of the present invention, when a hard disk drive (HDD) accesses a host system for the first time, the host system transmits authentication information, that is, a password, to the hard disk drive (HDD), and the HDD stores the password transmitted from the host system in a memory area therein, that is, a maintenance cylinder that only the HDD can access.

After the password is set, if there is an authentication request from a host system, the HDD compares a password provided from the host system with the password stored therein and then determines whether the host system is allowed to access the HDD. Further, if an authentication failure count is greater than a predetermined number, any access request received from the host system is rejected.

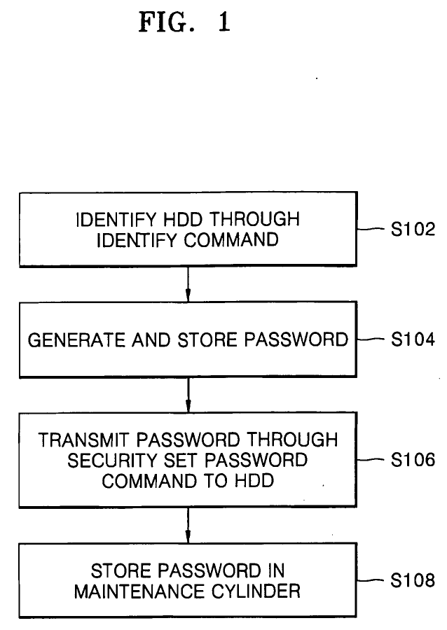

FIG. 1 is a flowchart illustrating a method of setting a password in an HDD in an authentication method according to an exemplary embodiment of the present invention.

Referring to FIG. 1, in operation S102, when the HDD is connected to a host system for the first time, the host system reads information including a model name and a serial number of the HDD by using an identify command.

In operation S104, the host system generates a password based on the model name and serial number of the HDD read through the identify command and stores the password in its memory area. The password may be generated using a polynomial whose factors include the model name and the serial number of the HDD, or the serial number of the HDD may be set to a default of the password.

In operation S106, the host system transmits the set password to the HDD through a security set password command. The security set password command includes the password.

In operation S108, the HDD stores the password transmitted through the security set password command in a maintenance cylinder.

Here, since the maintenance cylinder is a memory area that only the HDD can access, the host system cannot read the password of the HDD. Here, the host system and the HDD can encrypt and store the password. Security is further enhanced through the encryption.

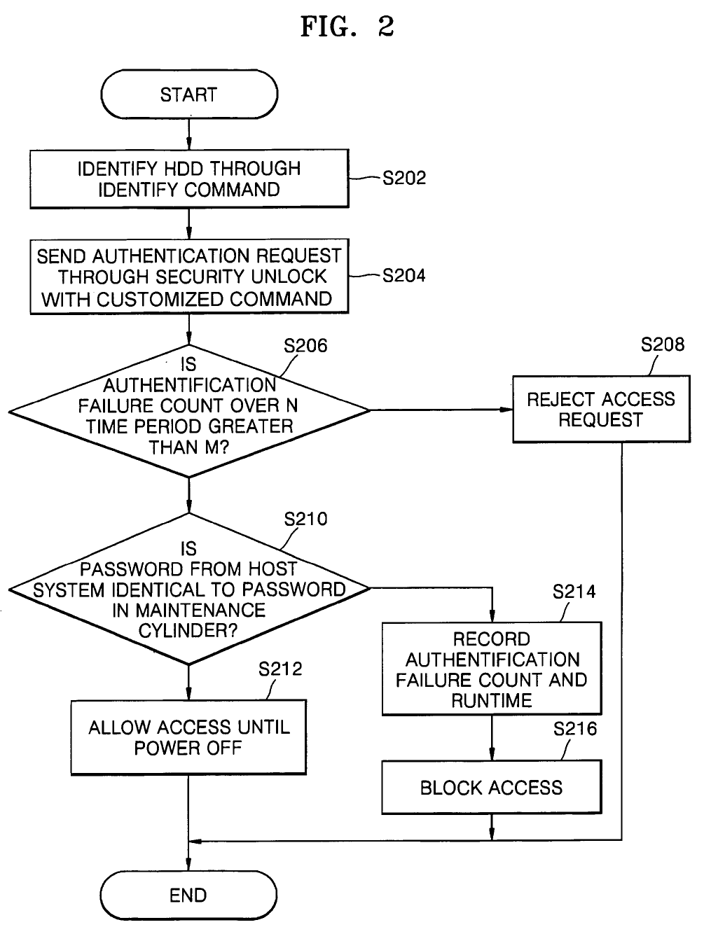

FIG. 2 is a flowchart illustrating an authentication method of the HDD according to an exemplary embodiment of the present invention.

Referring to FIG. 2, in operation S202, if the HDD having the set password is connected to the host system again, the host system identifies the model name and the serial number of the HDD by using an identify command.

In operation S204, the host system sends an authentication request to the HDD through a security unlock with customized command.

When sending the security unlock with customized command, the host system includes the password corresponding to the HDD identified through the identify command in the security unlock with customized command and then transmits the security unlock with customized command together with the password. The customized command itself includes the password.

In operation S206, the HDD receiving the security unlock with customized command checks an authentication failure count stored in the maintenance cylinder. If it is determined in operation S206 that the authentication failure count over an “n” time period before a cumulative runtime is greater than “m”, operation S208 is performed. In operation S208, the HDD rejects any access request from the host system.

If it is determined in operation S206 that the authentication failure count over the “n” time period before the runtime is not greater than “m”, operation S210 is performed. In operation S210, the HDD compares the password transmitted from the host system with the password stored in its maintenance cylinder.

If it is determined in operation S210 that the password transmitted from the host system is identical to the password stored in the maintenance cylinder, operation S212 is performed. In operation S212, the HDD allows the host system to access thereto until the HDD is turned off.

If it is determined in operation S210 that the password transmitted from the host system is not identical to the password stored in the maintenance cylinder, operation S214 is performed. In operation S214, the HDD records an authentication failure count increased by one and a runtime in the maintenance cylinder. In operation S216, the HDD blocks the access of the host system until the HDD is turned off. If the access of the host system is blocked in operation S216, the authentication procedure performed in operation S210 may be allowed when the HDD is connected to the host system again. However, if the access is rejected in operation S208, the authentication procedure performed in operation S210 is not allowed even though the HDD is connected to the host system again.

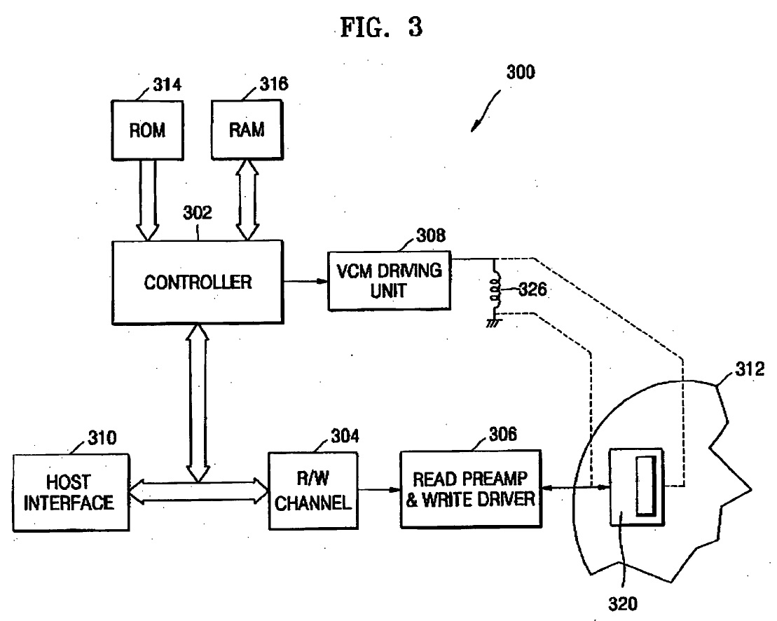

FIG. 3 is a block diagram of an HDD using an authentication method according to an exemplary embodiment of the present invention. Referring to FIG. 3, an HDD 300 according to an exemplary embodiment of the present invention includes a controller 302 operationally connected to both a read/write (RAN) channel circuit 304 and a read preamp & write driver circuit 306. The controller 302 may be a digital signal processor (DSP), a microprocessor, or a micro-controller.

The controller 302 provides a control signal to the RAN channel 304 to read data from a disk 312 or write data to the disk 312.

Information is typically transmitted from the RAN channel 304 to a host interface 310. The host interface 310 includes a control circuit for interfacing a system such as a personal computer.

The R/W channel circuit 304 converts an analog signal, which is read from a head 320 and is amplified by the read preamp & write driver circuit 306, into a digital signal, which can be read by a host computer (not shown), outputs the digital signal to the host interface 310, receives user data from the host computer via the host interface 310, converts the user data into a write current to be written to the disk 312, and outputs the write current to the read preamp & write driver circuit 306 in a generation mode.

The controller 302 is also connected to a VCM driving unit 308 that supplies a drive current to a voice coil 326. The controller 302 provides a control signal to the VCM driving unit 308 to control VCM excitation and head motion.

The controller 302 is connected to a non-volatile memory such as a read-only memory (ROM) 314 or a flash memory, and a random access memory (RAM) 316. The memories 314 and 316 include a command and data used to execute a software routine by the controller 302.

One of the software routines is a program for executing the authentication method according to an exemplary embodiment of the present invention. The program is stored in the non-volatile memory.

The controller 302 receives a command and data from the host system via the host interface 310. If a security unlock with customized command is received, the controller 302 first checks an authentication failure count stored in the maintenance cylinder, which is formed on disk 312. If it is determined that the authentication failure count over an “n” time period before a cumulative runtime is greater than “m”, the controller 302 rejects any access request from the host system.

If it is determined that the authentication failure count over the “n” time period is not greater than “m”, the controller 302 compares a password transmitted from the host system with a password stored in the maintenance cylinder. If the password transmitted from the host system is identical to the password stored in the maintenance cylinder, the controller 302 allows the host system to access thereto until power-off.

If the password transmitted from the host system is not identical to the password stored in the maintenance cylinder, the controller 302 records an authentication failure count increased by one, records a runtime, and blocks the access of the host system until power-off.

As described above, according to the authentication method of the present invention, the HDD compares the password received from the host computer with the password stored therein and allows the access of the host system only when the two passwords are identical to each other. Accordingly, only the authenticated host system can access the HDD.

Exemplary embodiments may be carried out in the form of a method, an apparatus, a system, and so on. In addition to the above described exemplary embodiments, exemplary embodiments of the present invention can also be implemented by executing computer readable code/instructions in/on a medium, e.g., a computer readable medium. The medium can correspond to any medium/media permitting the storing and/or transmission of the computer readable code.

The computer readable code/instructions can be recorded/transferred on a medium in a variety of ways, with examples of the medium including magnetic storage media (e.g., ROM, erasable ROM, floppy disks, hard disks, etc.), optical recording media (e.g., CD-ROMs, or DVDs), and storage/transmission media such as carrier waves, as well as through the Internet, for example. The medium may also be a distributed network, so that the computer readable code/instructions is stored/transferred and executed in a distributed fashion. The distributed network may be a wired network, wireless network, or combination thereof. The computer readable code/instructions may be executed by one or more processors.

Although a few exemplary embodiments of the present invention have been shown and described, it would be appreciated by those skilled in the art that changes may be made in these exemplary embodiments without departing from the principles and spirit of the invention, the scope of which is defined in the claims and their equivalents.

What is claimed is:

1. A method of authenticating a host system by a hard disk drive accessed by the host system, the method comprising:
determining whether authentication information received from the host system is identical to authentication information stored in the hard disk drive; and
blocking access of the host system to the hard disk drive until the hard disk drive is turned off the authentication information received from the host system is not identical to the authentication information stored in the hard disk drive.

2. The method of claim 1, further comprising:
recording an authentication failure count if the authentication information received from the host system is not identical to the authentication information stored in the hard disk drive; and
rejecting access from the host system if the authentication failure count is greater than a predetermined number.

3. The method of claim 2, wherein a runtime is recorded at the same time as the authentication failure count is recorded, and rejecting access from the host system if the authentication failure count over a predetermined time period before an accumulative runtime is greater than the predetermined number.

4. The method of claim 3, wherein the authentication failure count and the runtime are recorded in a maintenance cylinder of the hard disk drive.

5. The method of claim 1, further comprising transmitting an authentication request from the host system to the hard disk drive.

6. The method of claim 5, wherein the authentication request is sent to the hard disk drive by way of a security unlock with customized command.

7. The method of claim 1, further comprising:
the host system forming and transmitting the authentication information to the hard disk drive when the hard disk drive accesses the host system; and
the hard disk drive storing the authentication information transmitted from the host system in a maintenance cylinder.

8. A method of authenticating a host system by a hard disk drive accessed by the host system, the method comprising:
forming authentication information, wherein the host system forms the authentication information based on information read from the hard disk drive;
transmitting the authentication information to the hard disk drive when the hard disk drive accesses the host system for a first time;
storing the authentication information transmitted from the host computer for the first time in a maintenance cylinder, which can be accessed only by the hard disk drive.

9. The method of claim 8, further comprising:
determining whether authentication information received from the host system is identical to authentication information stored in the hard disk drive; and
blocking access of the host system to the hard disk drive until the hard disk drive is turned off if it is determined that the authentication information received from the host system is not identical to the authentication information stored in the hard disk drive.

10. The method of claim 9, further comprising:
recording an authentication failure count if the authentication information received from the host system is not identical to the authentication information stored in the hard disk drive; and
rejecting access from the host system if the authentication failure count is greater than a predetermined number.

11. The method of claim 10, wherein a runtime is recorded at the same time as the authentication failure count is recorded, and rejecting access from the host system if the authentication failure count over a predetermined time period before an accumulative runtime is greater than the predetermined number.

12. The method of claim 11, wherein the authentication failure count and the runtime are recorded in a maintenance cylinder of the hard disk drive.

13. The method of claim 8, further comprising transmitting an authentication request from the host system to the hard disk drive.

14. The method of claim 13, wherein the authentication request is sent to the hard disk drive by way of a security unlock with customized command.

15. At least one computer readable medium storing instructions that control at least one processor to perform a method of authenticating a host system by a hard disk drive accessed by the host system, comprising:
determining whether authentication information received from the host system is identical to authentication information stored in the hard disk drive; and
blocking access of the host system to the hard disk drive until the hard disk drive is turned off if the authentication information received from the host system is not identical to the authentication information stored in the hard disk drive.

16. The recording medium of claim 15, wherein the method further comprises:
recording an authentication failure count and a runtime if the authentication information received from the host system is not identical to the authentication information stored in the hard disk drive; and
when there is an authentication request from the host system, checking the authentication failure count and the runtime, and rejecting the access request of the host system if the authentication failure count over a predetermined time period before a cumulative runtime is greater than a predetermined number.

17. The recording medium of claim 15, wherein the method further comprises:
recording an authentication failure count if the authentication information received from the host system is not identical to the authentication information stored in the hard disk drive; and
rejecting access from the host system if the authentication failure count is greater than a predetermined number.

18. At least one computer readable medium storing instructions that control at least one processor to perform a method of authenticating a host system by a hard disk drive accessed by the host system, comprising:
forming authentication information, wherein the host system forms the authentication information based on information read from the hard disk drive;
transmitting the authentication information to the hard disk drive when the hard disk drive accesses the host system for a first time;
storing the authentication information transmitted from the host computer for the first time in a maintenance cylinder, which can be accessed only by the hard disk drive.

19. The medium of claim 18, further comprising:
determining whether authentication information received from the host system is identical to authentication information stored in the hard disk drive; and
blocking access of the host system to the hard disk drive until the hard disk drive is turned off if it is determined that the authentication information received from the host system is not identical to the authentication information stored in the hard disk drive.

20. The medium of claim 19, further comprising:
recording an authentication failure count if the authentication information received from the host system is not identical to the authentication information stored in the hard disk drive; and
rejecting access from the host system if the authentication failure count is greater than a predetermined number.

21. The medium of claim 20, wherein a runtime is recorded at the same time as the authentication failure count is recorded, and rejecting access from the host system if the authentication failure count over a predetermined time period before an accumulative runtime is greater than the predetermined number.

22. The method of claim 21, wherein-the authentication failure count and the runtime are recorded in a maintenance cylinder of the hard disk drive.

23. The method of claim 18, further comprising transmitting an authentication request from the host system to the hard disk drive.

24. The method of claim 23, wherein the authentication request is sent to the hard disk drive by way of a security unlock with customized command.
